(19) United States
(12) Patent Application Publication
(10) Pub. No.: US 2008/0173126 A1
(43) Pub. Date: Jul. 24, 2008

(54) Motorcycle handlebar grip cover

(75) Inventor: Kenneth E. Madden, Somerset, WI (US)

Correspondence Address: DICKE, BILLIG & CZAJA, PLLC, Suite 2250, 100 South Fifth Street, Minneapolis, MN, 55402, US

(73) Assignee: Kuryakyn Holdings, Inc.

(21) Appl. No.: 12/009,125

(22) Filed: Jan. 16, 2008

Related U.S. Application Data
(60) Provisional application No. 60/881,892, filed on Jan. 23, 2007.

(51) Int. Cl. B62K 21/26

(52) U.S. Cl. 74/551.9

(57) ABSTRACT

A motorcycle handlebar grip cover comprises a pair of mating hemicylindrical cover members. Each cover member is comprised of a first cavity portion configured to cover a grip portion of a motorcycle handlebar grip, and a second cavity portion configured to cover a flange of the motorcycle grip. The cover members connect to one another when the inner surface of each cover member engages the outer surface of the grip.

### BACKGROUND

The present invention generally relates to custom accessories for a motor vehicle, such as a motorcycle. In particular, the present invention relates to a cover accessory for a motorcycle handlebar grip.

Consumers have shown a strong interest in customizing their motorcycles by adding accessories to enhance the appearance of the motorcycle. It is common for a stock motorcycle to include basic black rubber handlebar grips. As shown in FIG. 1, a typical handlebar grip 10 is generally cylindrical with a grip portion 12 and a radial flange 14 at one end, which has a greater diameter than the grip portion 12. The opposite end of the grip 10 is generally aligned with the end of the handlebar 18. The grip has an inner cylindrical surface which is slid over an end portion 16 of the motorcycle handlebar 18, or in the case of the right-side grip, over a throttle tube carried at the end of the handlebar 14. The stock grips 10 are commonly secured to the handlebar 18 and the throttle tube with an adhesive to ensure that the grips do not move axially relative to the handlebar/throttle tube. In the case of the left-side grip, the grip is also secured from rotational movement relative to the handlebar.

If it is desired to enhance the appearance of the motorcycle grips, the stock grips have to be removed from the handlebar/throttle tube and replaced with entirely new grips. The grip removal process is labor intensive and involves cutting the existing grip and peeling it off the handlebar, removing the old adhesive and cleaning and preparing the handlebar/throttle tube to receive the new grips. The installation process of new grips is also labor intensive and requires proper application of adhesive to the mating surfaces of the grip and the handlebar/throttle tube and curing time of the adhesive before the grips are suitable for use. The grip replacement process is a particularly involved process if the stock motorcycle is equipped with heated grips. The ability to alter the aesthetics of stock handlebar grips without have to remove the existing grips is an improvement in the art.

### SUMMARY OF THE INVENTION

The present invention is a cover for a motorcycle handlebar grip that has a grip portion and a flange. The cover comprises two hemicylindrical shells that mate together to cover the grip portion and the flange. A first generally hemicylindrical shell has a first end, a second end and a shell wall extending between the first and second ends. The shell wall of the first shell has an outer surface, an inner surface and defines opposing first and second edges between the first and second ends. A first portion of inner surface of the first shell wall defines a first cavity having a first radius, and a second portion of the inner surface of the first shell wall defines a second cavity having a second radius greater than the first radius. A second generally hemicylindrical shell has a first end, a second end and a shell wall extending between the first and second ends. The shell wall of the second shell has an outer surface, an inner surface and defines opposing first and second edges between the first and second ends. A first portion of inner surface of the second shell wall defines a first cavity having a first radius, and a second portion of the inner surface of the second shell wall defines a second cavity having a second radius greater than the first radius. The cover further comprises means for connecting the first shell and the second shell together, the first cavities of the first and second shells thereby defining a generally cylindrical cavity for covering and engaging the grip portion of the motorcycle handlebar grip, and the second cavities of the first and second shells thereby defining a generally circular cavity for covering and engaging first and second sides of the flange of the motorcycle handlebar grip.

### BRIEF DESCRIPTION OF THE DRAWINGS

FIG. 1 is a diagrammatic view of a typical stock motorcycle handlebar grip mounted on a handlebar;

FIG. 2 is an exploded side view of the motorcycle handlebar grip cover assembly of the present invention positioned relative to a stock motorcycle handlebar grip;

FIG. 3 is a bottom plan view of a first grip cover member of the motorcycle handlebar grip cover assembly of FIG. 2;

FIG. 4 is a cross-sectional view of the motorcycle handlebar grip cover assembly of FIG. 2 taken along line 4-4;

FIG. 5 is an enlarged exploded partial end perspective view of the motorcycle handlebar grip cover assembly of FIG. 2;

FIG. 6A is a cross-sectional view of a first alternative embodiment of the motorcycle handlebar grip cover of the present invention;

FIG. 6B is a cross-sectional view of a second alternative embodiment of the motorcycle handlebar grip cover of the present invention;

FIG. 7 is a partial perspective view of a motorcycle handlebar with a heated handlebar grip;

FIG. 8 is an exploded partial side view of a motorcycle handlebar grip cover assembly for covering a heated handlebar grip on a right-side handlebar of a motorcycle;

FIG. 9 is an exploded partial side elevation of a motorcycle handlebar grip cover assembly for covering a heated handlebar grip on a left-side handlebar of a motorcycle;

FIG. 10 is a bottom plan view of a third alternative embodiment of a first motorcycle handlebar grip cover member for covering a left-side handlebar grip, which is shown in cross-section;

FIG. 11 is an exploded end view of a grip cover assembly comprised of the first grip cover member of FIG. 10 and a second grip cover member;

FIG. 12 is a side view of a fourth alternative embodiment of a motorcycle handlebar grip cover assembly of the present invention;

FIG. 13 is a side perspective view of a sleeve of the grip cover assembly of FIG. 12.

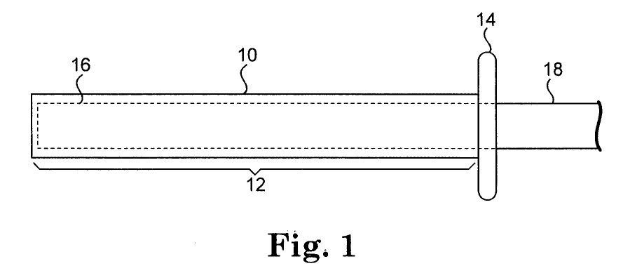

### DETAILED DESCRIPTION

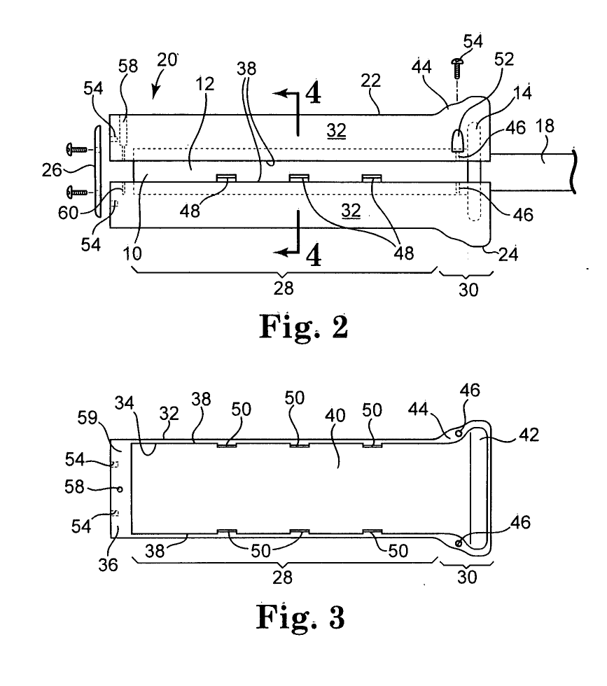

FIG. 2 is an exploded side view of the motorcycle handlebar grip cover assembly 20 of the present invention positioned over a motorcycle handlebar grip 10 (shown in phantom) that is mounted on a motorcycle handlebar 18. Grip cover assembly 20 generally comprises a first cover member 22, a second cover member 24, and an end plate 26. As shown in FIGS. 2 and 3, cover members 22 and 24 each comprise a generally hemi-cylindrical shell, a first portion 28 of which is configured to cover the grip portion 12 of grip 10, and a second portion 30 of which is configured to cover the flange 14 of grip 10. Cover members 22 and 24 are each formed from a sturdy thin-walled material, such as aluminum or suitable polymer. Suitable polymers for molding the cover members 22, 24 include acrylonitrile butadiene styrene (ABS), polyester, polycarbonate, fiber reinforced plastics, and the like. The outer surfaces of cover members 22, 24 may be chrome plated for aesthetics.

Cover members 22 and 24 each comprise an outer surface 32, an inner surface 34, an end wall 36 at a first end of each cover member, and edges 38, which extend from the end wall 36 to the second portion 30, which defines a second end of each cover member. The inner surface 34 of the first portion 28 of each cover member 22, 24 defines a first cavity 40 configured to match the generally cylindrical outer surface of the grip portion 12 of grip 10. The inner surface 34 of the second portion 30 of each cover member 22, 24 defines a curved second cavity 42 which is configured to match the outer perimeter and upper portion of adjacent sides of the flange 14 of grip 10. A portion 44 of the wall defining cover members 22, 24 is configured to have increased wall thickness between cavity 40 and cavity 42 to accommodate bores 46 for securing cover members 22 and 24 together. Edges 38 of cover member 22 seat against edges 38 of cover member 24 when cover members 22 and 24 are installed over the existing grip 10.

As shown in FIG. 2, in one embodiment cover member 24 includes one or more tabs 48 which extend above the edges 38 of cover member 24. Tabs 48 are configured to engage complimentary connectors 50 (FIG. 3) formed along edges 38 of cover member 22, when the respective edge portions 38 of cover members 22 and 24 are seated against one another. Tabs 48 and connectors 50 ensure that the edges 38 of cover members 22 and 24 are held together initially in the assembly process, and remain together after assembly of cover members 22, 24. Edges 38 of cover members 22, 24 may be connected together by other means consistent with the scope of the disclosed specific embodiment.

As shown in FIGS. 2 and 3, bores 46 of cover member 22 extend from outer surface 32 to edges 38. The portion 44 of the wall forming cover member 22 is skived along outer surface 32 to form channels 52 to create an access to bores 46 for threaded connectors 54. Bores 46 of cover member 24 are configured with internal threads to receive threaded connectors 54 and thereby secure cover members 22 and 24 together in the vicinity of second portion 30. In one embodiment, the end walls 36 of cover members 22 and 24 are configured with a plurality of axially oriented threaded bores 54 for connection of end plate 26, which secures end walls 36 together. In an alternate optional embodiment, end wall 36 of cover member 22 is configured with a stepped radial bore 58 that extends from outer surface 32 to edge 59 of end wall 36. Radial bore 58 aligns with a complimentary internally threaded bore 60 in the end wall 36 of cover member 24. Optional bores 58 and 60 provide an alternate means of connecting the end walls 36 of cover members 22 and 24 together with a threaded connector.

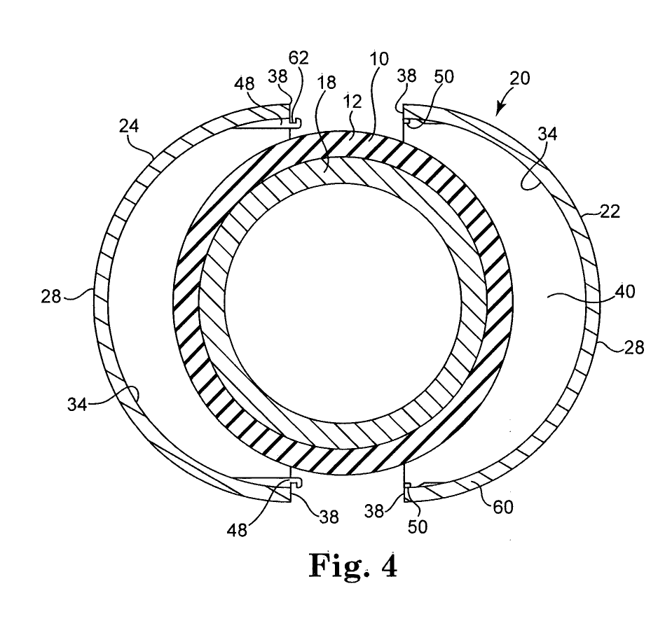

FIG. 4 is a cross-sectional view of the grip cover assembly 20 of FIG. 2 taken along line 4-4. As shown in FIG. 4, portion 28 of each cover member has a radius of curvature which closely matches the radius of curvature of the outer surface of the grip portion 12 of grip 10 such that when tabs 48 engage connectors 50, the material forming grip 10 is under compression. Thus, the frictional contact of the inner surfaces 34 of portion 28 of cover members 22 and 24 with grip 10 is sufficient to keep cover members 22 and 24 from axial and longitudinal movement relative to grip 10.

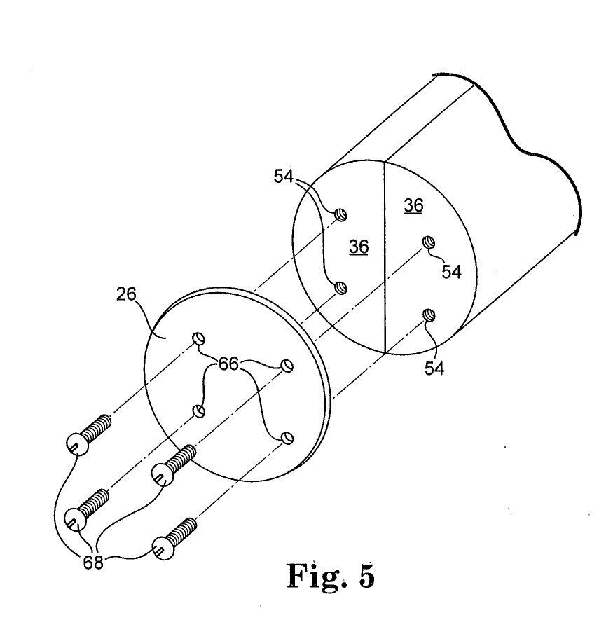

In one preferred embodiment, connectors 50 are projections which extend radially inward from edges 38 forming a lip. Connectors 50 are integrally formed with the arcuate wall 60 forming cover member 22. Tabs 48 each are configured with a transverse groove 62 adjacent to edges 38. Grip cover assembly 20 is installed over an existing grip by positioning cavity 40 of one of cover members, e.g., cover member 22, over grip portion 12 and cavity 42 over flange 14. The opposite cover member, e.g., cover member 24 is then positioned over the opposite side of grip 10. Cover members 22, 24 are manually squeezed together until connectors 50 fit within the transverse grooves 62 of tabs 48, thereby securing edges 38 together. As shown in FIG. 5, end walls 36 of cover members 22, 24 fit together to cover the end of grip 10. End plate 26 has mounting holes 66 which align with internally threaded bores 54 formed in end walls 36. End plate 26 mounts to end walls 36 with screws 68 and secures end walls 36 of cover members 22, 24 together.

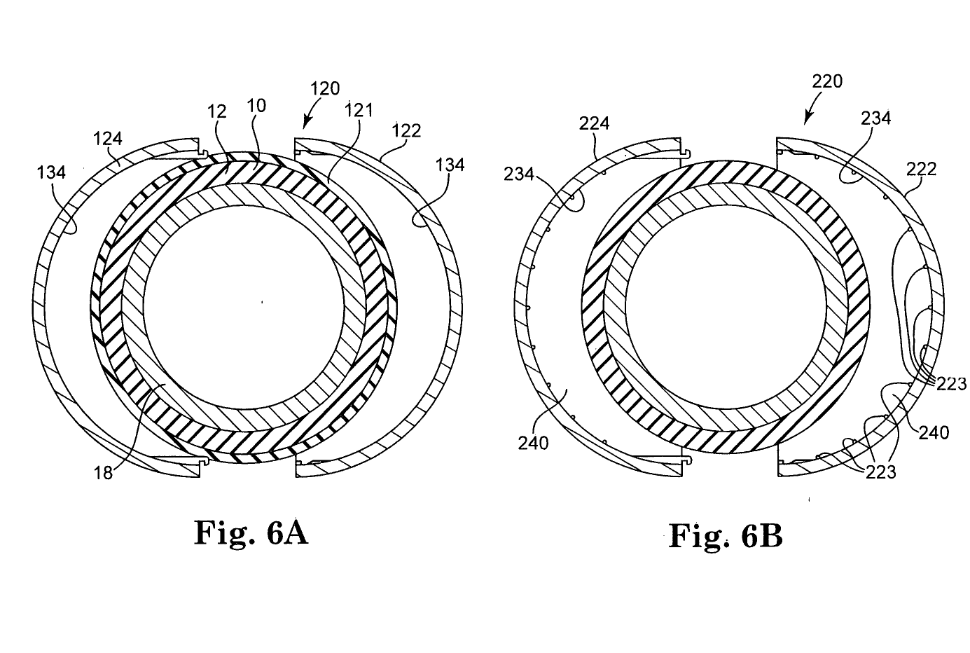

FIG. 6A is an exploded cross-sectional view of a first alternative embodiment of grip cover assembly 120. Grip cover assembly 120 is substantially identical to grip cover assembly 20 with the addition of a cylindrical sleeve 121 positioned over grip portion 12 of grip 10. Sleeve 121 may be formed from a suitable flexible material, such as rubber. Sleeve 121 may be configured to adjust for fluctuations in the outer diameter of grip portion 12 to ensure that the inner surfaces 134 of cover members 122 and 124 make good contact along the length of grip 10.

FIG. 6B is exploded cross-sectional view of a second alternative embodiment of grip cover assembly 220. Grip cover assembly 220 is substantially identical to grip cover assembly 20 with the addition of means on the inner surfaces 234 of cover members 222 and 224 for increasing the frictional contact between cover members 222, 224 and grip portion 12 of grip 10. In one embodiment, the means for increasing frictional contact comprise a plurality of inward radiating raised portions 223 of inner surfaces 234 along cavity 240. Raised portions 223 are configured to engage a superficial layer of the material forming grip 10 along the length of grip portion 12 to ensure that grip cover assembly 220 does not rotate or move axially relative to grip 10. Raised portions 223 may have varying dimensions to aid in adjusting for variability in the outer diameter of grip 10 along the length of grip portion 12. In alternative embodiments, the inner surface 234 may eliminate raised portions 223 and be fitted with an adhesive tape.

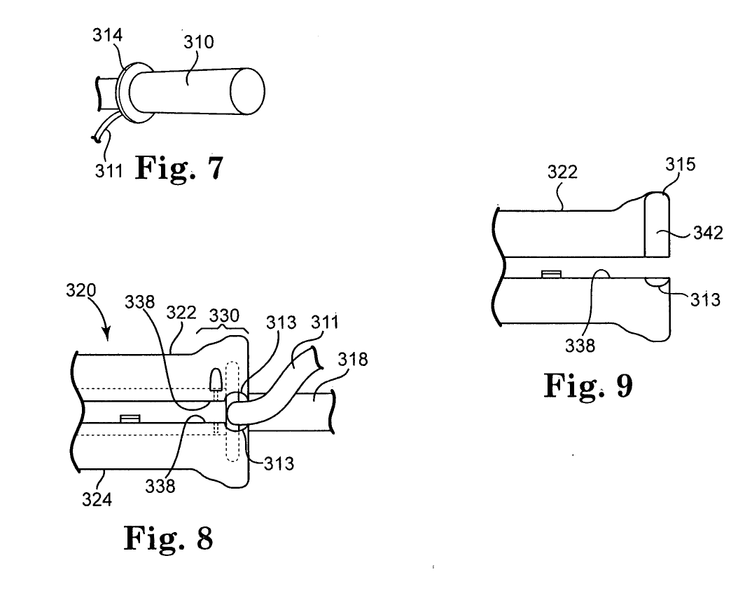

FIGS. 7-9 show alternative embodiments of a grip cover assembly configured for use with heated grips 310, which comprise embedded heating elements in the grip body. As shown in FIG. 7, heated grips 310 typically include an electrical lead wire ˜311 that is routed through flange 314 to the embedded heating elements in grip 310. FIG. 8 is an enlarged partial view of cover assembly 320 configured for use on a heated motorcycle grip connected to the throttle tube on the right handlebar 318 of a motorcycle. As shown in FIG. 8, to accommodate electrical lead wire 311, cover members 322, 324 are configured with semi-circular side wall cut-outs 313 in the wall of second portion 330 along edges 338. The side wall cut-outs 313 are configured such that when cover members 322 and 324 are fully assembled, wire 311 is captured in the opening defined by cut-outs 313. Cut outs 313 provide redundant assurance that grip cover assembly 320 does not move axially and rotationally relative to grip 310 and that the throttle tube rotates when grip cover assembly is rotated.

FIG. 9 is an enlarged partial view of cover assembly 320 configured for use on a heated motorcycle grip connected to the left handlebar of a motorcycle. As shown in FIG. 9, cover member 324 comprises a semi-circular side wall cut-out 313 along edge 338 in the vicinity of second portion 330, and cover member 322 comprises an enlarged side wall cut-out 315. When cover members 322 and 324 are connected together, cut-outs 313 and 315 form an arcuate wall opening adjacent to cavity 342 that is substantially longer than the width of wire 311, which allows the grip cover assembly on the left handlebar a degree of mounting adjustability so it can match the mounting orientation of the grip cover assembly on the right handlebar grip.

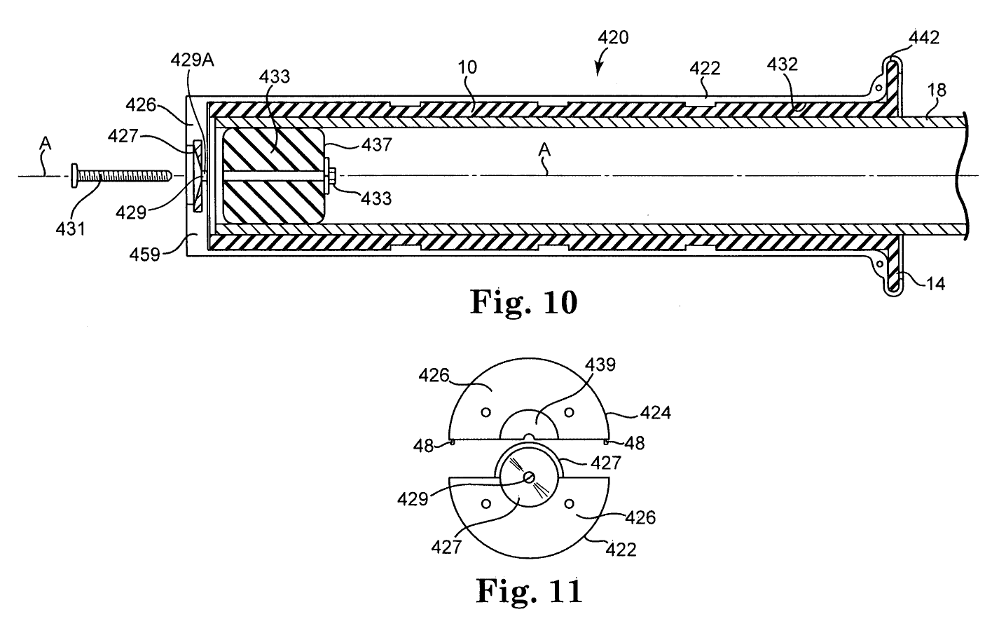

FIG. 10 is a bottom plan view of an alternate embodiment of a grip cover assembly 420 for mounting on grip 10 of the left handlebar 18. As shown in FIG. 10, cover member 422 is mounted over grip 10, with grip 10 and handlebar 18 shown in cross-section. Cover member 422 is substantially identical to cover member 22, with the addition of redundant means for anchoring the end walls 426 of cover members 422, 424 to the handlebar 18. As shown in FIG. 10, cavity 442 of cover members 422, 424, like cavity 42 of cover members 22, 24, is curved and captures flange 14 on opposite sides of flange 14 such that upon installation, grip cover assembly 420 is secured from axial movement relative to grip 10. Likewise, as previously described, the close frictional contact of the inner surface 432 of cover members 422, 424 with the outer surface of grip 10 prevents rotational movement of the grip cover assembly relative to the grip. As an added measure, grip cover assembly 420 is configured with a mounting flange 427 that extends from the edge 459 of end wall 426 toward cover member 424 (FIG. 11). Mounting flange 427 is configured with a recessed hole 429 that is coaxial with axis A of handlebar 18 when cover member 422 is mounted over grip 10. Edge 459 of end wall 426 is configured with a channel 429A also coaxial with axis A. Mounting flange 427 enables grip cover member 422 to be secured to the end of the handlebar 18 via known mounting devices, e.g., an expandable hub 433 located within handlebar 18. In one embodiment, flange 427 is connected to the expandable hub 433 by a mounting bolt 431, which passes through hole 429, channel 429A and a bore of an expandable hub 433 and threads into a nut 435 mounted on an internal end 437 of the expandable hub 433. As bolt 431 is rotated, the internal end 437 of the expandable hub is drawn toward flange 427, causing hub 433 to expand radially and thereby become secured to the inner surface of handlebar 18. In this manner, cover member 422 is further secured from axial and/or radial movement relative to grip 10. As shown in FIG. 11, end wall 426 of cover member 424 is configured with a complimentary cavity 439 which receives flange 427 when cover members 422 and 424 are assembled together. End walls 426 of cover members 422 may be secured together in the manner previously described relative to grip cover assembly 20.

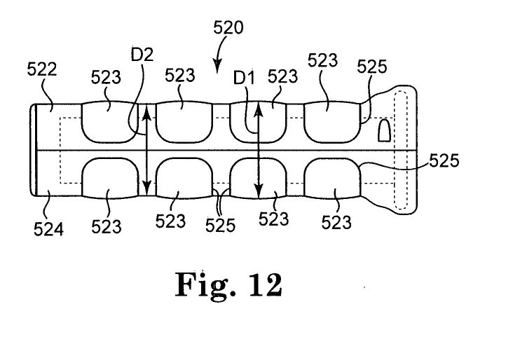

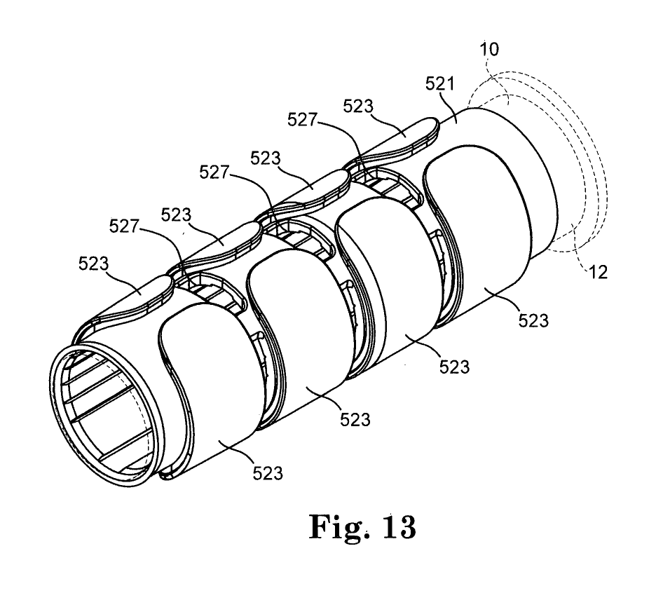

FIG. 12 is a side view of a fourth alternative embodiment of a motorcycle handlebar grip cover assembly 520 of the present invention. Grip cover assembly 520 is substantially similar to grip cover assembly 120 (FIG. 6A) in that grip cover assembly 520 comprises cover members 522 and 524 positioned over a sleeve 521 (FIG. 13) which is positioned over the grip portion 12 of grip 10. Unlike sleeve 121 of grip cover assembly 120, sleeve 521 comprises raised portions 523. Cover members 522, 524 are configured with wall openings 525 that correspond to the shape of raised portions 523, thereby allowing raised portions 523 to protrude through openings 525. Raised portions 523 define a diameter D1 of sleeve 521 which is greater than a diameter D2 of assembled cover members 522, 524. As a result, the soft feel of a rubber grip can be retained while the aesthetic appearance of the grip is enhanced by the contrasting metal covers. The number, shape and location of raised portions and cover wall openings may be varied. The sleeve wall may include a plurality of wall cut-outs 527 radially and axially spaced along sleeve 521. Cut-outs 527 improve the flexibility and maneuverability of sleeve 521 to facilitate placement of sleeve 521 as it is slid into position over grip 10.

The grip cover assembly of the present invention provides a quick and simple means for altering the aesthetics of existing motorcycle handlebar grips without having to completely remove and replace the existing grips. The thin wall of the cover members keeps the diameter of the grip cover assembly relatively close to the original diameter of the stock grips being covered, and in the case of heated grips allows heat from the grips to be transmitted through the covers to retain the heating function of the existing heated grips. The outer surface 32 of cover members 22 and 24 may be shaped and/or adorned to achieve a desired appearance and/or tactile appeal. While various specific embodiments have been disclosed, it is intended that the various embodiments may be employed individually or collectively in combination with each other.

Although specific embodiments have been illustrated and described herein, it will be appreciated by those of ordinary skill in the art that a variety of alternate and/or equivalent implementations may be substituted for the specific embodiments shown and described without departing from the scope of the present invention. Therefore, it is intended that this invention be limited only by the claims and the equivalents thereof.

What is claimed is:

1. A cover for a motorcycle handlebar grip having a grip portion and a flange, the cover comprising:
a first generally hemicylindrical shell having a first end, a second end and a shell wall extending between the first and second end, the shell wall having an outer surface, and inner surface and defining opposing first and second edges between the first and second ends, a first portion of inner surface of the shell wall defining a first cavity having a first radius, a second portion of the inner surface of the shell wall defining a second cavity having a second radius greater than the first radius;
a second generally hemicylindrical shell having a first end, a second end and a shell wall extending between the first and second end, the shell wall having an outer surface, and inner surface and defining opposing first and second edges between the first and second ends, a first portion of inner surface of the shell wall defining a first cavity having a first radius, a second portion of the inner surface of the shell wall defining a second cavity having a second radius greater than the first radius;
means for connecting the first shell and the second shell together, the first cavities of the first and second shells defining a generally cylindrical cavity for covering and engaging the grip portion of the motorcycle handlebar grip, and the second cavities of the first and second shells defining a generally circular cavity for covering and engaging first and second sides of the flange of the motorcycle handlebar grip.

2. The cover of claim 1 wherein the means for connecting comprises a plurality of first connectors extending from the inner surface of the first shell adjacent to the first and second edges of the first shell, a plurality of second connectors along the inner surface of second shell adjacent to the first and second edges of the second shell, the first connectors being configured to engage the second connectors when the first and second edges of the first shell are in contact with the first and second edges of the second shell to hold the respective first and second edges of the first and second shells together.
